(19) United States
(12) Patent Application Publication
(10) Pub. No.: US 2010/0225567 A1
(43) Pub. Date: Sep. 9, 2010

(54) ELECTRONIC DISPLAY

(75) Inventors: Jeffry Koebrich, Danville, IL (US); Carl Roth, St. Joseph, IL (US)

Correspondence Address: DICKSTEIN SHAPIRO LLP, 1825 EYE STREET NW, Washington, DC, 20006-5403, US

(73) Assignee: Time-O-Matic, Inc.

(21) Appl. No.: 12/396,943

(22) Filed: Mar. 3, 2009

(51) Int. Cl. G09G 3/20; G09G 3/32; H01R 43/00

(52) U.S. Cl. 345/55; 345/82; 29/592.1

(57) ABSTRACT

An electronic display comprising a pixel array having staggered pixels and a processor. Methods of operating and manufacturing the electronic display comprising a pixel array having staggered pixels and a processor are also disclosed,

### BACKGROUND

The invention relates to electronic displays, and methods of operating and manufacturing electronic displays.

Electronic displays for displaying images are typically designed as regular arrays of light sources called picture elements, or “pixels.” Each pixel emits light to reproduce a small piece of the image being displayed. For color displays, each color pixel typically includes more than one light emitter, called “sub-pixels.” The color pixels usually include at least one red, one blue, and one green sub-pixel.

An electronic display signal includes the information needed for creating the image on the display. The display signal includes information corresponding to each pixel. The signal received by the pixel includes values corresponding to an amplitude of light for each of the corresponding one or more sub-pixels to generate. When a pixel includes multiple sub-pixels of different colors, the relative amplitudes of the sub-pixels determine the displayed color that is perceived by a viewer. The precise arrangement of sub-pixels, such as blue, red, and green sub-pixels, is not visible at appropriate viewing distances.

Pixels in a display are typically arranged in an array of rows and columns. Conventional pixel arrays have rows and columns of pixels arranged at right angles, also known as an “orthogonal” pixel array. FIG. 1 shows an orthogonal pixel array 100, with pixels 150 arranged in orthogonal rows 111 and columns 112. While, for purposes of explanation, the pixel display 100 shows only seven rows and seven columns of pixels, it should be understood that a typical orthogonal pixel array may include hundreds or thousands of rows and columns.

Types of light emitters used in pixels known in the art include light-emitting-diodes (LED's). For example, the sub-pixels of one type of LED pixel may include one red, one green, and one blue LED. Other commonly known types of light emitters used in pixels include plasma, liquid crystal display (LCD), and cathode ray tube (for small displays), to name but a few.

Pixel arrays having LED pixels may be constructed using either “through-hole” or “surface-mount” type devices, as are known in the art. Through-hole devices, on the one hand, include discrete LED sub-pixels or discrete LED pixels which are mounted individually on a circuit board by fitting wire leads of the discrete elements into holes in the circuit board. Surface-mount devices, on the other hand, are mounted directly onto the surface of, and electrically connected to, a circuit board having wiring already printed on its surface to correspond to the wiring of the surface-mount devices.

A pixel array with a high number of pixels in the surface area of a circuit board—also referred to as a higher resolution of pixels—is typically capable of producing a clearer image at a given viewing distance. The distance between neighboring pixels (measured, for example, from the center of each pixel) is commonly referred to as the pixel “pitch.”

Referring back to the pixel array 100 shown in FIG. 1, the distance between neighboring pixels may be measured as a vertical pitch 115 (i.e., between horizontally-aligned pixels of neighboring rows 111), a horizontal pitch 116 (i.e., between vertically-aligned pixels of neighboring columns 112), or a diagonal pitch 117 (i.e., between non-aligned pixels of neighboring rows 111 and columns 112). Common vertical pitch values for large commercial displays include, for example, 16 millimeters, 19 millimeters, 25 millimeters, or 36 millimeters. Typically, the horizontal pitch and the vertical pitch of an orthogonal pixel array are equal.

The images to be displayed on the above-described electronic displays are often initially captured and stored in high resolution formats, also arranged in orthogonal rows and columns of pixels. For example, an image of a person to be displayed may be captured by a camera at a resolution of 12 megapixels. An image captured at a 12 megapixel resolution means that the image consists of pixel signals corresponding to approximately 12 million pixels. In an orthogonal pixel array, this would include approximately 4,000 columns and 3,000 rows of pixels (for a 4:3 aspect ratio).

Often, however, electronic displays do not have the same number of pixels as the captured images they are intended to display. For example, rather than 4,000 rows and 3,000 columns of pixels, the pixel array of an electronic display may only have 2,000 rows and 1,500 columns of pixels.

It is desirable to use information from the higher resolution image signal to produce a higher resolution displayed image. It is typically true that pixel arrays with higher resolutions are achieved by reducing the pitch. Manufacturing orthogonal pixel arrays with reduced pitch, however, increases manufacturing costs related to materials and compliance with quality controls. Further, additional pixels typically require additional power, thus increasing the power consumption of an electronic display.

In order to portray images stored at a high resolution on lower resolution electronic displays, the electronic displays may include a pixel processor that reduces the pixel data by averaging algorithms of various complexities. For example, U.S. Pat. No. 7,123,277 to Brown Elliott et al. describes a method of converting pixel signals formatted for a high resolution pixel array to pixel signals formatted for a lower resolution pixel array by performing an involved averaging process with multiple calculations for each sub-pixel. Such an intense sub-pixel by sub-pixel process can result in increased complexity and computation time for the required processor and an increase in delay between receiving and outputting the pixel signals.

Another proposed solution to this inherent tradeoff between an electronic display's resolution and costs has been to create “virtual pixels” by using sub-pixel elements from one pixel and sub-pixel elements from an adjacent pixel. For example, US published patent application no. 2006/0055642 to Daughenbaugh et al. teaches an orthogonal pixel array, where sub-pixel elements from each pixel are shared with sub-pixel elements from a neighboring pixel. Similarly, related U.S. Pat. Nos. 6,661,429, 7,091,986, 7,215,347, and 7,286,136 to Phan et al. create virtual (or “dynamic”) pixels by sharing sub-pixels of orthogonally-arranged rows of pixels. While the method in these disclosures may be able to achieve a higher perceived resolution than an orthogonal pixel display that does not share sub-pixels, these techniques often require heavy processing of the pixel signals, and thus more expensive components and/or higher power consumption, as well as the potential for delay between receiving and transmitting the pixel signals.

Yet another proposed solution to the tradeoff between resolution and costs has been to provide offset rows of pixels having specifically-arranged sub-pixels. For example, US published patent application no. 2008/0225143 to Joffer et al. teaches a pixel array having horizontally offset horizontal lines of LED pixels to allow for tighter vertical spacing. However, the pixel array in Joffer also performs complex sub-pixel sharing, and thus requires specific arrangements of sub-pixels. Further, because the pixel arrays in Joffer are dependent upon precise sub-pixel locations, increased manufacturing costs for quality control may also be incurred.

Accordingly, an electronic display having increased apparent resolution with improved manufacturing and operating cost is desired.

### SUMMARY

An electronic display having a pixel array with staggered pixels and a processor configured to combine and transmit pixel signals corresponding to an orthogonal pixel array to the pixels, in a manner described herein. Pixel locations in the pixel array are either occupied locations or vacant locations, with the pixels of the staggered rows being located in the occupied locations, and no pixel being located in the vacant locations.

Portions of pixel signals corresponding to the vacant locations are combined with pixel signals corresponding to neighboring occupied locations. The portions of the pixel signals corresponding to the vacant locations that are combined with pixel signals corresponding to neighboring occupied locations may be equal proportions, for example, one-quarter or one-eighth of the original pixel signal. Pixel signals corresponding to occupied locations receiving the portions may be adjusted proportionately, according to the portions received from neighboring vacant locations.

Embodiments of an electronic display having a pixel array with staggered pixels may be manufactured from an orthogonal pixel array. Operation of the embodiments described herein is independent of sub-pixel location or arrangement within each individual pixel, and does not include the sharing of sub-pixels between pixels. Embodiments described herein address the challenge of increasing resolution with minimal increased manufacturing and operating costs.

### BRIEF DESCRIPTION OF THE DRAWINGS

FIG. 1 is a schematic view of an orthogonal pixel array of a prior art electronic display.

FIG. 2 is a schematic view of an electronic display having a pixel array and a processor, in accordance with embodiments described herein.

FIG. 3 is a schematic view of a pixel array of an electronic display having staggered rows, in accordance with a preferred embodiment.

FIG. 4 shows the distribution of pixel signals, in accordance with the embodiment of FIG. 3.

FIG. 5 is a view like FIG. 4.

FIG. 6 is a view like FIG. 4.

### DETAILED DESCRIPTION OF PREFERRED EMBODIMENTS

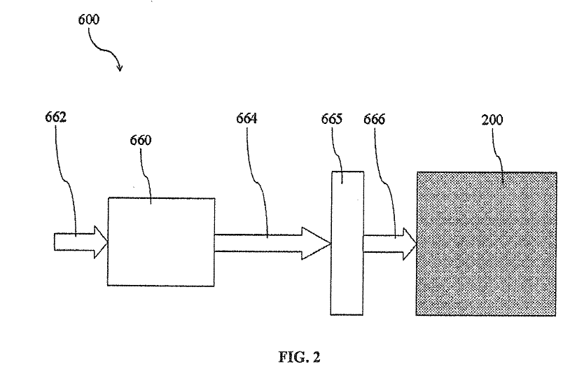

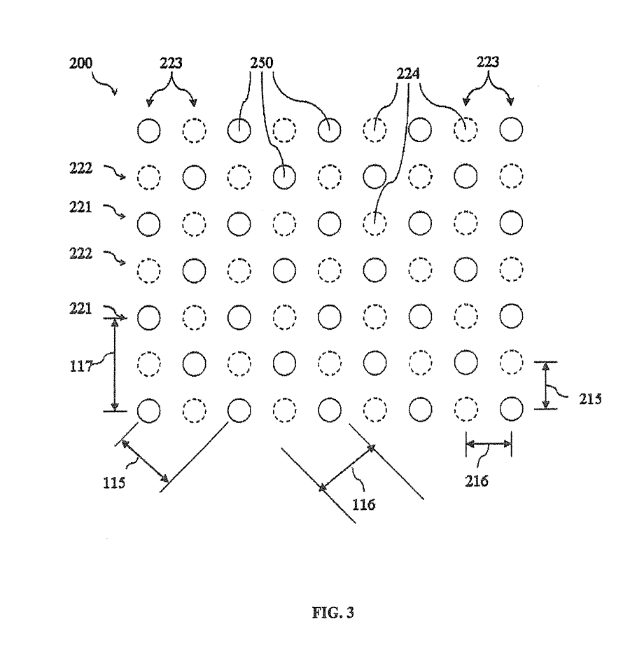

Refer now to FIGS. 2 and 3, there being shown an electronic display 600 including a pixel array 200 and a processor 660, in accordance with a preferred embodiment. The pixel array 200 has staggered rows of pixels, as described below. The processor 660 receives a plurality of pixel signals 662 corresponding to each pixel of an orthogonal pixel array and outputs a plurality of pixel signals 664 corresponding to each pixel of the pixel array 200, as further described below.

The output pixel signals 664 are transmitted to control circuitry 665 of the pixel array 200. The control circuitry 665 includes circuitry related to each pixel in the pixel array 200. The respective circuitry 665 for each pixel receives the corresponding pixel signal from the processor 660, and sends control signals 666 to trigger the pixel (or its respective sub-pixels) to generate a corresponding amplitude of light.

The pixels of the pixel array 200 are preferably LED pixels, having one or more LED's, either colored or uncolored, as sub-pixel elements. The pixels of the pixel array 200 may instead be plasma pixels, cathode pixels, or any other type of pixel known in the art. The pixel array 200 may be constructed using either “through hole” or “surface-mount” type devices, as are known in the art.

FIG. 3 shows a pixel array 200 having staggered rows 221, 222 of pixels 250. For descriptive purposes, it is useful to consider the pixels 250 as being located in occupied locations, while vacant locations 224 exist between the pixels 250 of each row. No pixel is located in the vacant locations 224. If a pixel was located in each of the vacant locations 224, then the pixel array would be orthogonal. Each vacant location 224 (except for vacant locations on a perimeter wall of the pixel array 200, as discussed below) is surrounded by four neighboring existing pixels 250 in occupied locations. Similarly, each pixel 250 (except for pixels on a perimeter wall or in a corner, as discussed below) is surrounded by four vacant locations 224.

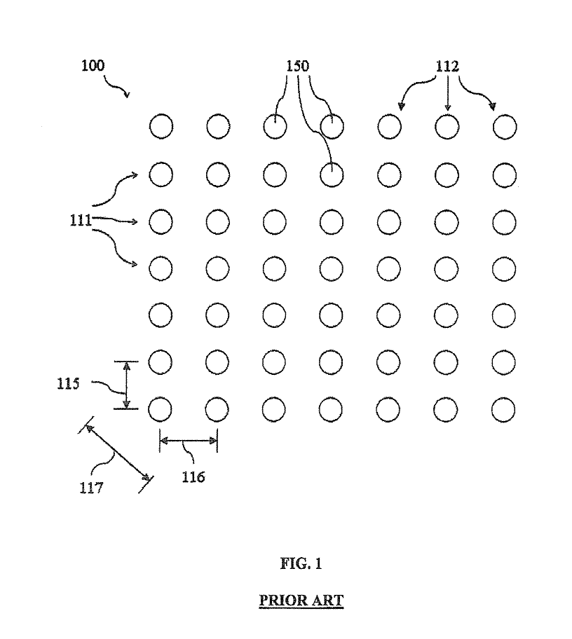

For example, in manufacturing an electronic display, an orthogonal pixel array (i.e., the orthogonal pixel array 100 of FIG. 1) could be rotated 45 degrees. It should be understood that, while counterclockwise rotation would result in the arrangement of pixels in FIG. 3, clockwise rotation would result in a similar pixel array with staggered rows of pixels. The resulting pixel array 200 provides a smaller vertical pitch 215 between the pixel rows 221, 222, and smaller horizontal pitch 216 between the pixel columns 223 than the vertical pitch 115 and horizontal pitch 116 of the orthogonal pixel array 100 in FIG. 1. If the array 100 shown in FIG. 1 had a vertical pitch 115 and a horizontal pitch 116 of approximately 23 millimeters, then a pixel array 200 resulting from a rotation of forty-five degrees, as shown in FIG. 3, would have staggered pixel rows 221, 222 having a vertical pitch 215 and a horizontal pitch 216 of approximately 16 millimeters, but the pixels of the vacant locations 224 are “missing.” The vertical pitch 215 of the resulting pixel array 200 is one-half of the diagonal pitch 117 of the orthogonal pixel array. In an orthogonal pixel array having the same vertical pitch 215 as pixel array 200, each vacant location 224 would have a pixel.

Thus, pixel array 200 is comparable to an orthogonal pixel array with every other pixel “missing,” creating a type of “checkerboard pattern” with nothing in the vacant locations 224 and with the pixels 250 in the occupied locations. If the pixel array 200 contained the same amount of pixels as orthogonal pixel display 100 (FIG. 1), while the number of pixels per area would be effectively the same, the vertical pitch 215 and the horizontal pitch 216 of the pixel array 200 would be reduced. It should be understood that, while the pixel array 200 in FIG. 3 shows only nine rows and nine columns of pixels, a typical pixel array would include hundreds or thousands of rows and coltuns.

Moreover, the arrangement of pixels 250 and vacant locations 224 in the pixel array 200 allows for an increase in apparent resolution without the corresponding increase in costs due to increased pixels per area. As discussed above, each vacant location 224 in the pixel array 200 of FIG. 3 is surrounded on each of four sides by pixels 332 in occupied locations. As discussed above, in an orthogonal pixel array having the same pitch as the “checkerboard” pattern of the pixel array 200 of FIG. 3, pixels would be present in the vacant locations 224. Thus, when the electronic display 600 (FIG. 2) receives pixel signals of a format corresponding to an orthogonal pixel array having the same pitch 115, 116 of the pixel array 200 in FIG. 2, it receives a pixel signal corresponding to each of the pixels 250, as well as a pixel signal corresponding to each of the “missing” pixels, i.e., to the vacant locations 224. To avoid discarding pixel signals corresponding to the “missing” pixels, the processor 660 of the electronic display 600 (FIG. 2) allocates the signal to neighboring pixels 250 to increase the apparent resolution of the array 200.

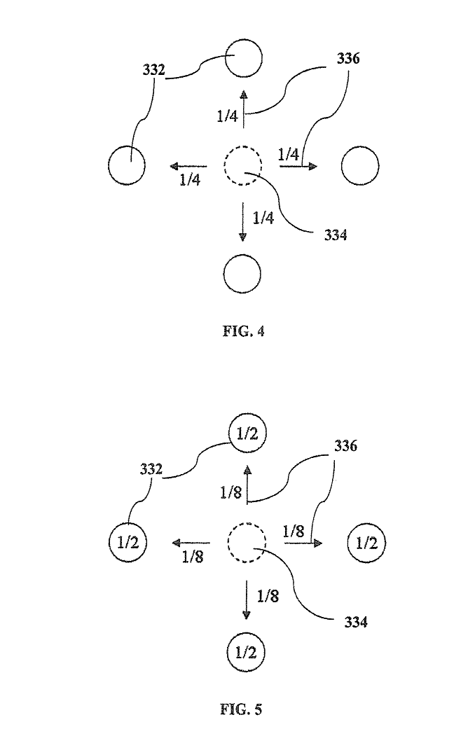

Examples of the functions performed by the processor 660 are described with respect to FIGS. 4 and 5. It should be understood that while the term “pixel signal” refers to a signal corresponding to a pixel, in many embodiments each pixel will include multiple sub-pixels, as discussed above. Thus, each “pixel signal” may include multiple sub-pixel signals.

FIG. 4 shows the distribution of equal portions 336 of a pixel signal corresponding to a vacant location 334 of a pixel array to four neighboring pixels 332. As shown in FIG. 4, one quarter (¼) of the pixel signal corresponding to the “missing” pixel of the vacant location 334 is sent to each of the neighboring pixels 332 in the surrounding occupied locations. The sub-pixel signals for the missing pixels would be distributed to similarly-colored elements of the existing pixels 250. So, for example, signals for red sub-pixels of the missing pixels would be distributed to the red sub-pixels of the neighboring existing pixels.

In FIG. 5, in another embodiment, the amplitude of the pixel signals corresponding to the pixels 332, as well as the portions 338 of the pixel signal corresponding to the vacant location 334, are reduced by half. One eighth (⅛) of the pixel signal corresponding to the vacant location 334 is combined with one half (½) of each of the pixel signals corresponding to the neighboring pixels 332,. In this manner, a pixel 332 receiving portions of pixel signals from four neighboring vacant locations (i.e., the vacant locations, not all shown in FIG. 5, to the right, left, above, and below of the pixel 332) will receive a pixel signal corresponding to one whole (i.e., 8/8) of a pixel signal. Of course, it should be understood that, by effectively reducing all signals by one-half (½) before the signals are received by the processor 660 (FIG. 2), the operation shown in FIG. 4 will effectively distributing one-eighth of the “missing” pixel signals to neighboring pixels, as shown in FIG. 5.

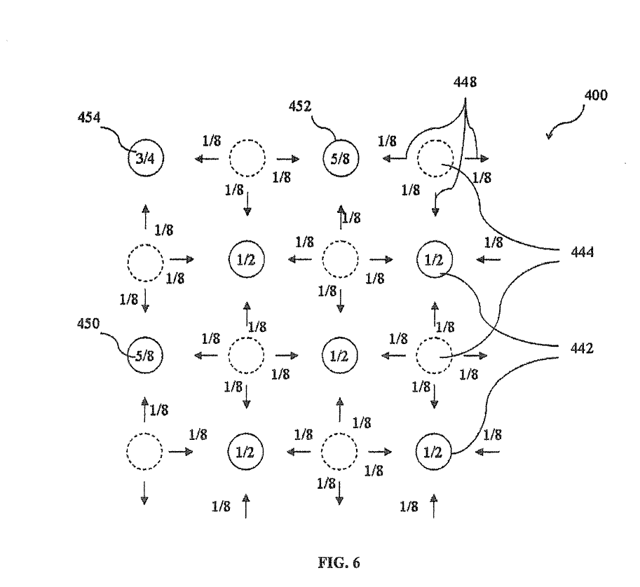

FIG. 6 shows a segment of a pixel array 400 having a plurality of pixels 442 in occupied locations and vacant locations 444 where pixels are “missing.” Portions 448 of pixel signals corresponding to the vacant locations 444 are distributed to respective neighboring pixels 442. As discussed above with regard to FIG. 5, the pixel signals corresponding to the occupied locations including pixels 442 are reduced by half and combined with one eighth amplitude of the pixel signals corresponding to each of the four neighboring vacant locations 444.

Further, the shown segment of the pixel array 400 includes perimeter pixels 450, 452 and a corner pixel 454. The perimeter pixels 450, 452 are located on a side perimeter (top, bottom, left, or right) of the pixel array 400. Of course, it should be understood that, while only perimeter pixels on the left and top side perimeters are shown, that is because only a segment of the pixel array 400 is shown in FIG. 6. Perimeter pixels would also be located along the rest of the top and left perimeters of the pixel array, as well as along the bottom and right perimeters of the pixel array.

Because there is no vacant location to the left of the perimeter pixel 450 on the left side, or above the perimeter pixel 452 on the top side, the perimeter pixels 450, 452 receive portions of pixel signals corresponding to only three neighboring vacant locations 444. Thus, the amplitudes of the pixel signals corresponding to the perimeter pixels 450, 452 are only reduced to five eighths (⅝) of their original value (with one eighth coming from each of the pixel signals corresponding to the three neighboring vacant locations).

As shown in FIG. 6, the corner pixel 454 is in the top left corner of the displayed segment of the pixel array 400. A corner pixel 454 would also be located in each of corner of the pixel array 400. Because the corner pixel 454 receives portions of pixel signals corresponding to only two neighboring vacant locations 444, the amplitude of the pixel signal corresponding to corner pixel 454 is only reduced to six eighths ( 6/8 or ¾) of its original value (with one eighth coming from each of the pixel signals corresponding to the two neighboring vacant locations).

The operation of the electronic display described herein is independent of the individual sub-pixel arrangement on each respective pixel. Pixels with different arrangements of sub-pixels may be used in the same pixel array. So, for example, a pixel element having a red sub-pixel arranged over a blue sub-pixel and a green sub-pixel could be used next to a pixel having a green sub-pixel arranged over a red sub-pixel and a blue sub-pixel. Further, sub-pixels of neighboring pixels need not be in exact alignment. Because the described embodiments operate independent of the particular sub-pixel arrangement, the requirements for complex processing and strict quality control of manufactured arrays may be greatly reduced.

Accordingly, an electronic display comprising a pixel array having staggered rows of pixels, and a processor for combining portions of pixel signals corresponding to an orthogonal pixel array for displaying on the staggered pixel array is described. The electronic display provides for increased perceived resolution with minimal cost increase by staggering the pixel rows, and distributing portions of pixel signals corresponding to vacant pixel locations to neighboring pixels. For example, for a given resolution specification of an orthogonal pixel array, half the number of pixels may be used to construct the pixel array of the electronic display described above, with similar resolution.

In addition to reducing manufacturing costs, decreasing the number of parts results in higher product reliability. Further, the reduced number of actual pixels needed for the pixel array results in less control circuitry being needed. Thus, larger pixel arrays may be constructed and operated with the same number of control electronics as smaller orthogonal pixel arrays.

Example embodiments of methods, systems, and components thereof have been described herein. As noted elsewhere, these example embodiments have been described for illustrative purposes only, and are not limiting. The breadth and scope of the present invention should not be limited by any of the above described exemplary embodiments, but should be defined only in accordance with the following claims and their equivalents.

What is claimed as new and desired to be protected by Letters Patent of the United States is:

1. An electronic display configured to display an image, said electronic display comprising:
a pixel array having:
a plurality of staggered rows of occupied locations, wherein said occupied locations include pixels; and
a plurality of vacant locations neighboring said occupied locations; and
a processor configured to receive pixel signals corresponding to an orthogonal pixel display, and to combine portions of pixel signals corresponding to said vacant locations with pixel signals corresponding to respective neighboring occupied locations.

2. The electronic display of claim 1, wherein said processor is configured to output said combined pixel signals to control circuitry of said pixel array.

3. The electronic display of claim 1, said pixels of said pixel array further comprising a plurality of sub-pixels.

4. The electronic display of claim 3, wherein said plurality of sub-pixels comprises a red, a green, and a blue sub-pixel.

5. The electronic display of claim 3, each of said received pixel signals including signals corresponding to a plurality of sub-pixels, and each of said combined pixel signals including a sub-pixel signal corresponding to each of said plurality of sub-pixels of said pixels.

6. The electronic display of claim 5, wherein said processor is configured to combine received signals corresponding to similarly-colored sub-pixels.

7. The electronic display of claim 1, wherein each of said portions of pixel signals are one fourth of the amplitude of each of said received pixel signals corresponding to said vacant locations.

8. The electronic display of claim 1, wherein said processor is configured to reduce said pixel signals corresponding to said occupied locations by one half, and wherein each of said portions of pixel signals are one eighth of the amplitude of each of said pixel signals corresponding to said vacant locations.

9. The electronic display of claim 8, said pixel array further comprising a perimeter pixel in an occupied location at an edge of said pixel array, wherein said processor is configured to reduce a pixel signal corresponding to said perimeter pixel to five eighths of its amplitude.

10. The electronic display of claim 8, said pixel array further comprising a corner pixel in an occupied location at a corner of said pixel array, wherein said processor is configured to reduce a pixel signal corresponding to said corner pixel to six eighths of its amplitude.

11. The electronic display of claim 1, wherein said pixels are LED pixels.

12. The electronic display of claim 11, wherein each of said LED pixels comprise at least one of:
a surface-mount device; and
a through-hole device.

13. A method of operating an electronic display having a plurality of staggered rows of occupied locations having pixels and vacant locations between each of said occupied locations, said method comprising:
receiving pixel signals corresponding to a pixel array having pixels arranged in orthogonal rows;
for each of said occupied locations, combining:
a received pixel signal corresponding to said occupied location; and
portions of each of said received pixel signals corresponding to all neighboring vacant locations of said respective occupied location; and
transmitting said combined pixel signals to respective control circuitry of each of said pixels of said occupied locations.

14. The method of claim 13, wherein said received pixel signals each comprise a plurality of sub-pixel signals.

15. The method of claim 14, further comprising:
combining sub-pixel signals of each of said received pixel signals corresponding to said occupied locations with portions of similarly-colored sub-pixel signals corresponding to said neighboring vacant locations.

16. The method of claim 13, wherein said portions of said first subset of pixel signals are one fourth of the amplitude of each of said first subset of pixel signals.

17. The method of claim 13, further comprising reducing said second subset of pixel signals by one half, wherein said portions of said first subset of pixel signals are one eighth of the amplitude of each of said first subset of pixel signals.

18. The method of claim 17, further comprising reducing a pixel signal corresponding to a perimeter pixel to five eighths of its amplitude.

19. The method of claim 17, further comprising reducing a pixel signal corresponding to a corner pixel to six eighths of its amplitude.

20. The method of claim 13, wherein said method of operating said electronic display is independent of an arrangement of sub-pixels.

21. A method of manufacturing an electronic display, said method comprising:
providing a pixel array with orthogonal rows of pixels having a first pitch;
rotating said pixel array 45 degrees to form an array having staggered rows of pixels; and
providing a processor configured to:
receive pixel signals corresponding to orthogonal rows of pixels having a second pitch, wherein said second pitch is narrower than said first pitch;
combine portions of pixel signals corresponding to vacant locations of said rotated pixel array with pixel signals corresponding to neighboring occupied locations of said rotated pixel array; and
transmit said combined pixel signals to pixels of said occupied locations.

22. The method of claim 21, wherein said pixels are LED pixels.

23. The method of claim 22, the step of providing a pixel array further comprising installing LED pixels of at least one of:
a through-hole device; and
a surface-mount device.

24. The method of claim 21, wherein said processor is configured to output said combined pixel signals to control circuitry of respective pixels in said neighboring occupied locations.

25. The method of claim 20, wherein said first pitch is approximately 23 millimeters, and said second pitch is approximately 16 millimeters.
